(19) United States
(12) Patent Application Publication
(10) Pub. No.: US 2025/0373606 A1
(43) Pub. Date: Dec. 4, 2025

(54) METHODS AND APPARATUSES FOR PROVIDING DEVICES ACCESS TO A PRIVATE OR PUBLIC NETWORK

(71) Applicant: Comcast Cable Communications, LLC, Philadelphia, PA (US)

(72) Inventors: Naveen Kumar Raju Vysyaraju, Philadelphia, PA (US); Farman Ibayev, Philadelphia, PA (US); Rajat Ghai, Philadelphia, PA (US); Soumya Munshi, Philadelphia, PA (US); Raja Shah, Philadelphia, PA (US)

(21) Appl. No.: 18/679,658

(22) Filed: May 31, 2024

(51) Int. Cl. H04L 9/40

(52) U.S. Cl. CPC H04L 63/0876; H04L 63/083; H04L 63/101

(57) ABSTRACT

Methods, systems, and apparatuses are described for providing devices access to a private or public network. A computing device may provide access to the private network or the public network for a user device that randomizes its device identifier (e.g., a Media Access Control (MAC) address). Access to the private network or the public network may be determined based on information associated with the user device and the computing device.

### BACKGROUND

A network device acts as an entry or exit point for data traffic between different networks. The network device may provide access to a private network (e.g., a home network) and a public network (e.g., a hotspot). For example, the network device may broadcast a private WiFi home network and a public network, which are two different isolated networks. A user device may accidentally connect to the public network while located at a residence associated with the user of the user device. In such cases, the user device is not connected to the user's private home network and the user device would not be able to access some of the private network services, such as casting, local printing, and any other services requiring the user device to be accessing the private network. This may impact the user's WiFi experience at that particular location.

### SUMMARY

It is to be understood that both the following general description and the following detailed description are exemplary and explanatory only and are not restrictive. Methods, systems, and apparatuses for providing devices access to one of a private network or a public network are described. For example, a network device such as a gateway may provide a user device access to a private or public network. The user device may randomize its device identifier (e.g., a random Media Access Control (MAC) address) when it accesses to the private or public network. The network device may not authorize the user device to access to the private or public network based on the device identifier (e.g., a randomly-generated, or random, MAC address). In this case, access to the private network or the public network may be determined based on information associated with the user device and the network device.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows an example system;

FIG. 2 shows another example system;

FIG. 3A shows an example communications flow;

FIG. 3B is a continuation of FIG. 3A;

FIG. 4 shows another example communications flow;

FIG. 5 shows example network parameters;

FIG. 6 shows a flowchart of an example method;

FIG. 7 shows a flowchart of an example method;

FIG. 8 shows a flowchart of an example method; and

FIG. 9 shows a block diagram of an example computing device.

### DETAILED DESCRIPTION

As used in the specification and the appended claims, the singular forms “a,” “an,” and “the” include plural references unless the context clearly dictates otherwise.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

Described herein are methods, systems, and apparatuses for providing devices access to a private or public network. For example, a network device (e.g., a gateway, an access point, or the like) at a user's home may be configured to provide access to a private WiFi network and a public WiFi network (e.g., hotspot). A user device may try to access the public WiFi network instead of the private WiFi network at the user's home or residence. For example, a user device with a rotating/random Media Access Control (MAC) address may send a request to connect to the public WiFi network at the user's home. Based on the random MAC address, the network device may determine that the user device is not authorized to connect to the public WiFi network. In such a case, the network device may further request the user device to provide the user information (e.g., user credentials, user identification, or the like). Upon receiving the user information, the network device may send an authorization request to a network server. The authorization request may include the user information and the MAC address associated with the network device. Based on the location of the network device and the user information, the user device may or may not connect to the public WiFi network. For example, if the network device is located in the user's home, the network device may receive an access reject message and deny the user device to connect to the public WiFi network. If the network device is located outside of the user's home, the network device may receive an access accept message and allow the user device to connect to the public WiFi network.

As described above, a network device such as a gateway device or an access point may broadcast a private network (e.g., a user private WiFi home network) and a public network (e.g., hotspot). These private and public networks are two different isolated networks. A user device at the user's home or residence may automatically get connected to the public network (e.g., based on the hotspot SSID) while at the user's home or residence. In such cases, the user device may not be accessing the private network (e.g., the user's private WiFi home network) and may not access some of the local area network (LAN) services, such as casting, local printing, and any services requiring the user device to be in the same user private home network. This may impact the user's WiFi experience in the home.

The methods, systems, and apparatuses described herein may prevent the user device from connecting to the public network provided by the network device at the user's home. For example, the network device (e.g., a gateway, an access point, or the like) may maintain a MAC-based access control list for all devices previously connected to or authorized by the network device (e.g., a gateway, an access point, or the like). The network device (e.g., a gateway, an access point, or the like) may prevent the user device from connecting to the public network based on the MAC-based access control list. This may be useful for cases where user devices do not randomize their MAC addresses for different WiFi networks.

In another example, a computing device (e.g., a server, such as a Radius/AAA server) may be used to direct user devices to the private network rather than the public network for the user devices that randomize their MAC addresses. Specifically, the computing device (e.g., the server, such as the Radius/AAA server) may validate the connectivity of the user device to the public network by validating the user information (e.g., user account credentials, user identification, or the like). For example, when the user device connects to the public network, the network device (e.g., a gateway, an access point, or the like) may send a request (e.g., an access request or an authorization request, such as a RADIUS access request) to the computing device (e.g., the server, such as the Radius/AAA server) with the information associated with the network device. The information associated with the network device may comprise one or more attribute value pairs (AVPs). One or more AVPs may include, but are not limited to, the network device's device identifier, such as a MAC address (e.g., gateway MAC address), a network type, and/or virtual local area network (VLAN) identity (VLAN ID).

The computing device (e.g., the server, such as the Radius/AAA server) may check the AVPs and validate the network device's device identifier, such as a MAC address (e.g., gateway MAC address), with one or more computing devices (e.g., servers, backend systems, or the like) based on the user information (e.g., user account credentials, user identification, or the like). The computing device (e.g., the server, such as the Radius/AAA server) may identify whether the connection request to the public network (e.g., hotspot) is received from the network device (e.g., a gateway, an access point, or the like) located in the user's home or not.

For example, if the connection request to the public network is received from the network device (e.g., a gateway, an access point, or the like) located in the user's home or residence, the computing device (e.g., the server, such as the Radius/AAA server) may send a message, such as a reject message (e.g., a Radius access-reject message) with reason=“GREYLIST,” to the network device. The network device (e.g., a gateway, an access point, or the like) may add the user device's device identifier (e.g., MAC address) to the access deny list for a period of time, for example, for 24 hours. The period of time may include any amount of time and can be measured in units such as seconds, minutes, hours, days, weeks, months, or years. The network device (e.g., a gateway, an access point, or the like) may stop the WiFi session establishment with the user device.

On the other hand, if the connection request is received by the network device (e.g., a gateway, an access point, or the like) outside of the user's home or residence, the computing device (e.g., the server, such as the Radius/AAA server) may send a message, such as an access-accept message to the network device, and the connection request to the public network may be accepted by the network device (e.g., a gateway, an access point, or the like) outside of the user's home.

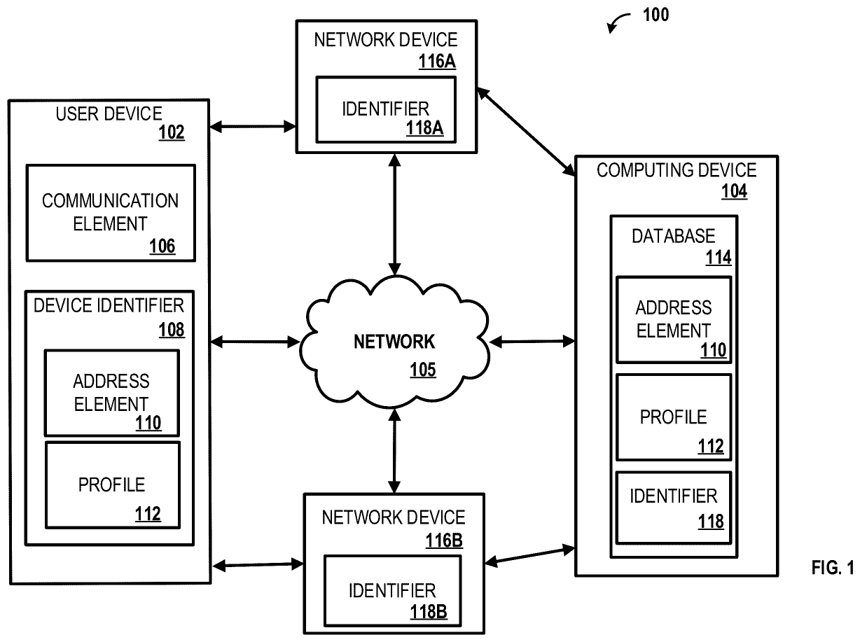

FIG. 1 shows an example system 100 for providing devices access to a private or public network. The system 100 may be configured to provide services, such as network-related services, to a device (e.g., user device 102, network devices 116A-116B, etc.). The network and system may comprise at least one user device 102 in communication with a plurality of network devices 116A-116B and/or a computing device 104, such as a server, for example, via network 105. The computing device 104 may be disposed locally or remotely relative to the user device 102 and the network devices 116A-116B. As an example, the user device 102, the network devices 116A-116B, and the computing device 104 may be in communication via the network 105 (e.g., a private or public network) such as the Internet or a local area network (LAN). Other forms of communications may be used, such as wired and wireless telecommunication channels, for example.

The user device 102 may comprise one or more computing devices or electronic devices such as computers, smartphones, laptops, tablets, set top boxes, display devices, or other devices capable of communicating with the network devices 116A-116B and/or the computing device 104. The user device 102 may comprise a communication element 106 for providing an interface to a user to interact with the user device 102 and/or the computing device 104. The communication clement 106 may be any interface for presenting and/or receiving information to/from the user, such as user feedback. An example interface may be a communication interface such as a web browser (e.g., Internet Explorer®, Mozilla Firefox®, Google Chrome®, Safari®, or the like). Other software, hardware, and/or interfaces may be used to provide communication between the user and one or more of the user device 102, the network devices 116A-116B, and/or the computing device 104. As an example, the communication clement 106 may request or query various files from a local source and/or a remote source. As a further example, the communication clement 106 may transmit data to a local or remote device such as the network devices 116A-116B and/or the computing device 104.

The user device 102 may be associated with a user identifier or a device identifier 108. As an example, the device identifier 108 may be any identifier, token, character, string, or the like, for differentiating one user or user device from another user or user device. As a further example, the device identifier 108 may identify a user or user device as belonging to a particular class of users or user devices. As a further example, the device identifier 108 may comprise information relating to the device 102 such as a manufacturer, a model or type of device, a service provider associated with the device 102, a state of the device 102, a locator, and/or a label or classifier. Other information may be represented by the device identifier 108.

The device identifier 108 may comprise an address clement 110 and a profile 112. The address element 110 may comprise or provide an internet protocol address, a network address, a media access control (MAC) address, international mobile equipment identity (IMEI) number, international portable equipment identity (IPEI) number, an Internet address, or the like. As an example, the address element 110 may be relied upon to establish a communication session between the device 102 and the network devices 116A-116D and/or the computing device 104 or other devices and/or networks. As a further example, the address element 110 may be used as an identifier or locator of the device 102. In an example, the address element 110 may be persistent for a particular network.

The profile 112 may comprise identification information (e.g., identification of a device and/or a device owner), information related to the environment is which the device operates (e.g., information related to a cable modem, an access point, and/or home gateway associated with the device and/or the device owner), an identification of a service provider, information related to a policy description describing the policy associated with the user and/or the user device 102, and/or the like. In an aspect, the profile 112 may comprise an identification of a service provider associated with the user device 102 and/or with the class of user device 102. The class of the user device 102 can be related to a type of device, capability of device, type of service being provided, and/or a level of service (e.g., business class, service tier, service package, etc.). As an example, the identification of the service provider of the profile 112 can comprise information relating to or provided by a communication service provider (e.g., Internet service provider) that is providing or enabling data flow such as communication services to the user device 102. As a further example, the identification of the service provider of the profile 112 can comprise information relating to a preferred service provider for one or more particular services relating to the user device 102.

In some aspect, the profile 112 may comprise identification information of the device or the device owner (e.g., a user profile). The user profile of the user device 102 may comprise a set of personalized settings, preferences, and information associated with a specific user account on that device. Examples of the user profile may include, but are not limited to, personal settings, user accounts, application preferences, accessibility options, and stored data. The personal preference settings may include, but are not limited to, language, display settings, and other customization options chosen by the user. The user accounts may include information related to the user's account, including their username, password, and other security settings. The application preferences may include settings and configurations specific to various applications installed on the user device 102. The accessibility options may include customizations to accommodate the user's accessibility needs, such as font size, color schemes, etc. The stored data may include files, documents, and media associated with the user's account.

In some aspects, the policy description of the profile 112 may further comprise a policy description regarding the services provided to the user. The policy description can be information that identifies a policy (e.g., an access or use policy). For example, where the policy comprises an allowed bandwidth, a quality of service designation, a list of allowed services, and/or the like, the policy description can comprise an indication of the allowed bandwidth, a quality of service designation, a listing of the allowed services, and/or other similar information. In an aspect, the address element 110 can be used to identify or retrieve data from the profile 112 or vice versa. As a further example, one or more of the address element 110 and the profile 112 can be stored remotely from the user device 102 and retrieved by one or more devices such as the user device 102 and the computing device 104. Other information can be represented by the profile 112.

The user device 102 may access to the network 105 (e.g., a private network or a public network) via the network devices 116A-116B and/or the computing device 104. For example, a network device 116A (e.g., a gateway, an access point, or the like) may be configured to provide access to a private WiFi network and a public WiFi network. The user device 102 may send, to the network device 116A, a first request to connect to the public WiFi network. The first request may comprise a random MAC address associated with the user device 102. The network device 116A may determine that the random MAC address is not allowed/authorized to connect to the public WiFi network. The user device 102 may receive a second request from the network device 116A. The second request may indicate the user device 102 to provide user information to connect to the public WiFi network. The user device 102 may send the user information (e.g., user credentials, user identification, or the like) to the network device 116A. The network device 116A may send the user information and a MAC address associated with the network device to the computing device 104 (e.g., a Radius/AAA server) for further verification. Based on the user information and the MAC address associated with the network device 116A, the user device 102 may connect or may not connect to the public WiFi network.

The user device 102, the network devices 116A-116B, and the computing device 104 may communicate between each other via network 105. The network 105, may include a packet-switched network (e.g., an Internet protocol-based network), a non-packet switched network (e.g., quadrature amplitude modulation-based network), and/or the like. The network 105 may include network adapters, switches, routers, modems, and the like connected through wireless links (e.g., radio frequency, satellite, etc.) and/or physical links (e.g., fiber optic cable, coaxial cable, Ethernet cable, or a combination thereof). The network 105 may include public networks, private networks, wide area networks (e.g., Internet), local area networks, and/or the like. The network 105 may be configured to provide communication from telephone, cellular, modem, and/or other electronic devices to and throughout the system 100.

The computing device 104 may comprise a server for communicating with the user device 102 and/or the network devices 116A-116B. As an example, the computing device 104 may communicate with the user device 102 and/or network devices 116A-116B for providing data and/or services. As an example, the computing device 104 may provide services, such as network (e.g., Internet) connectivity, network printing, media management (e.g., media server), broadband services, or other network-related services. The computing device 104 may allow the user device 102 to interact with remote resources, such as data, devices, and files.

The computing device 104 may be configured to manage the communication between the user device 102 and network devices 116A-116B. The computing device 104 may comprise a database 114 for storage of data sent/received to/from the user device 102 and/or network devices 116A-116B. As an example, the database 114 may store a plurality of files (e.g., web pages), user identifiers or records, or other information. As a further example, the user device 102 may request and/or retrieve a file from the database 114. The database 114 may store information relating to the user device 102 such as the address clement 110 and/or the service clement 112. As an example, the computing device 104 may obtain a device identifier 108 from the device 102 and retrieve information from the database 114 such as the address element 110 and/or the profile 112. As a further example, the computing device 104 may obtain the address element 110 from the device 102 and may retrieve the profile 112 from the database 114, or vice versa. Any information may be stored in and retrieved from the database 114. The database 114 may be disposed remotely from the computing device 104 and accessed via direct or indirect connection. The database 114 may be integrated with the computing device 104 and/or with any other device or entity within the system 100.

The computing device 104 may be configured to send instructions to the user device 102. The instructions may cause (e.g., via the user device 102) one or more user devices (e.g., network devices 116A-116B) to send one or more upstream transmissions. The user device 102 may be configured, as further described herein, to detect one or more signals associated with the one or more user devices sending the one or more upstream transmissions. The one or more signals detected by the user device 102 may be associated with one or more of a type, a classification, or a location(s) of one or network leaks as further described herein.

The computing device 104 may be an authentication, authorization, and accounting (AAA) server that implements a remote authentication dial-in user service (RADIUS) protocol. The AAA server may be a centralized server that handles the processes of authenticating users, authorizing their access to resources, and accounting for their activities. The computing device 104 (e.g., an AAA server) may verify the identity of a user, the user device 102 or network devices 116A-116B, typically through username and password, digital certificates, or other credentials. The computing device 104 (e.g., an AAA server) may determine the level of access and privileges that a user, the user device 102, or the network devices 116A-116B should have based on their authenticated identity. The computing device 104 (e.g., an AAA server) may track and record the activities of users, including logins, data usage, and other relevant information.

RADIUS may be a networking protocol that provides AAA services. The computing device 104 (e.g., an AAA server) may use the RADIUS to control access to network resources, especially in the context of dial-up and Virtual Private Network (VPN) connections. The computing device 104 (e.g., an AAA/RADIUS server) may be responsible for authenticating users, authorizing their access, and accounting for their network usage. The computing device 104 (e.g., an AAA/RADIUS server) may operate in a client-server model, where the network devices 116A-116B (e.g., routers or network access servers) act as clients that forward authentication requests to the computing device 104 (e.g., an AAA/RADIUS server).

For example, the computing device 104 (e.g., an AAA/RADIUS server) may receive an authentication request from a network device 116A (e.g., a gateway) to verify the connection request from the user device 102 to the network 105 (e.g., a public WiFi network). The authentication request may comprise user information associated with a user or the user device 102 and a MAC address associated with the network device 116A (e.g., a gateway). The computing device 104 (e.g., an AAA/RADIUS server) may determine whether the network device 116A is located in the user location associated with the user information or the user device 102. The computing device 104 (e.g., an AAA/RADIUS server) may determine whether the network device 116A is located in the user location associated with the user information or the user device 102 based on the user information and/or the MAC address associated the network device 116A. The computing device 104 (e.g., an AAA/RADIUS server) may communicate with other computing devices, servers, and/or network devices (e.g., network device 116B) to determine whether the network device 116A is located in the user location associated with the user information or the user device 102.

If the computing device 104 (e.g., an AAA/RADIUS server) determines that the network device 116A (e.g., a gateway) is located outside of the user location associated with the user information or the user device 102, the computing device 104 (e.g., an AAA/RADIUS server) may send an access accept message to the network device 116A (e.g., a gateway). The access accept message may indicate that the first computing device is located outside of the user location associated with the user information. If the computing device 104 (e.g., an AAA/RADIUS server) determines that the network device 116A is located in the user location associated with the user information or the user device 102, the computing device 104 (e.g., an AAA/RADIUS server) may send an access reject/deny message to the network device 116A (e.g., a gateway). The access reject/deny message may indicate that the network device 116A (e.g., a gateway) is located in the user location associated with the user information or the user device 102.

The network devices 116A-116B may be any device configured to communicate with the user device 102 and/or the computing device 104, for example, within a local network of the respective users/subscribers premises. For example, the network devices 116A-116B may be configured to interface with a display, an Internet of Things (IoT) device, a mobile device, one or more sensors, and/or the like. For example, the network devices 116A-116B may comprise user premises devices such as gateways, access points, set top boxes, cable boxes, routers, cable modems, network terminals, or any combination thereof. The network devices 116A-116B may be configured to interface with any local network device with an Internet Protocol (IP) and/or Media Access Control (MAC) address, such as a local computer, a wired and/or wireless router, a local content server, and/or the like. The network devices 116A-116B may forward data/information received from the user device 102 and/or the computing device 104 to any devices, for example, within a local network of the respective users/subscribers premises, and may forward data received from any device to the user device 102 and/or the computing device 104. The specific configuration of the network devices 116A-116B may vary. Each of the network devices 116A-116B may include a converter that may convert signals and/or data/information to signals and/or data/information suitable for any devices, for example, within a local network of the respective users/subscribers premises.

The network devices 116A-116B may be configured to facilitate the connection of a user device 102 (e.g., devices within a user's home) to the network 105. For example, the network devices 116A-116B may be configured as wireless access points (WAPs) or gateways. The network devices 116A-116B may be configured to allow one or more wireless devices to connect to a wired and/or wireless network using Wi-Fi, Bluetooth®, Zigbee®, or any desired method or standard. The network devices 116A-116B may comprise identifiers 118A-118B. As an example, one or more identifiers may be, or relate to, an Internet Protocol (IP) Address IPV4/IPV6 or a media access control address (MAC address) or the like. As a further example, the identifiers 118A-118B may be unique identifiers for facilitating communications on the physical network segment. Each of the network devices 116A-116B may comprise an identifier 118A-118B that is distinct. As an example, the identifiers 118A-118B may be associated with a physical location of the network devices 116A-116B.

The network devices 116A-116B may be configured to facilitate multiple connections to multiple networks. For example, a network device 116A (e.g., a gateway) may be configured to provide the user device 102 multiple networks, such as a private network (e.g., a user's home network) and a public network (e.g., hotspot). The network device 116A (e.g., a gateway) may receive a first request to connect to the public network from the user device 102. The first request may comprise a random Media Access Control (MAC) address associated with the user device 102. Upon receiving the first request, the network device 116A (e.g., a gateway) may determine whether the random MAC address is authorized for the user device 102 to connect to the public network. If the random MAC address is not authorized to connect to the public network, the network device 116A (e.g., a gateway) may send a second request to the user device 102. The second request may indicate the user device 102 to provide user information (e.g., user credentials, user identification, or the like) to connect to the public network.

The network device 116A (e.g., a gateway) may receive the user information and send an authorization request to the computing device 104 (e.g., an AAA/RADIUS server) for further verification. The authorization request may comprise the user information and a MAC address associated with the network device 116A (e.g., a gateway). Based on the user information and the MAC address associated with the network device 116A (e.g., a gateway), the network device 116A (e.g., a gateway) may receive an access accept message or an access reject message from the computing device 104. The access accept message may indicate that the network device 116A (e.g., a gateway) is located outside of the user location associated with the user information or the user device 102. Once the network device 116A (e.g., a gateway) receives the access accept message, the network device 116A (e.g., a gateway) may allow the user device 102 to access/connect to the public network. The access reject message may indicate that the network device 116A (e.g., a gateway) is located in a user location associated with the user information or the user device 102, the network device 116A (e.g., a gateway) may reject or deny the user device 102 to access/connect to the public network.

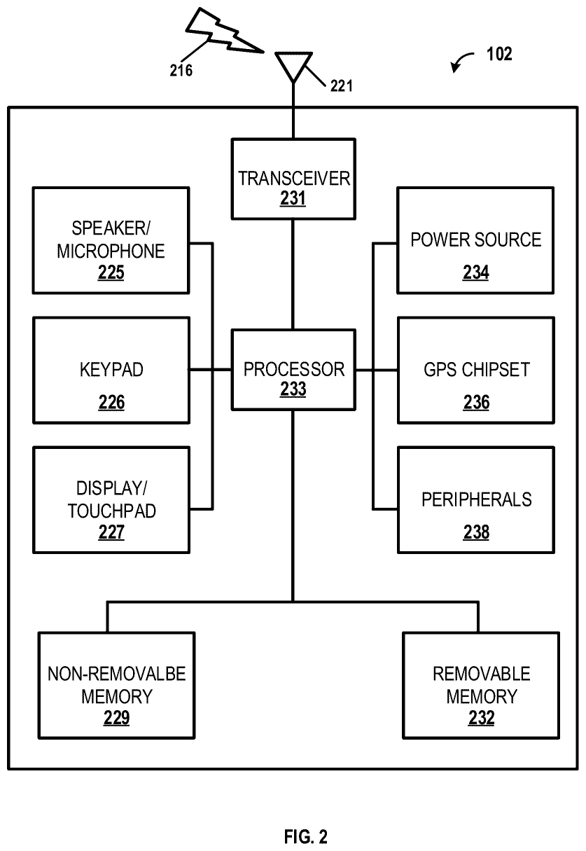

FIG. 2 shows is a system diagram illustrating an example user device 102. As shown in FIG. 2, the user device 102 may include a processor 233, a transceiver 231, a transmit/receive element 221, a speaker/microphone 225, a keypad 226, a display/touchpad 227, non-removable memory 229, removable memory 232, a power source 234, a global positioning system (GPS) chipset 236, and/or other peripherals 238, among others. It will be appreciated that the user device 102 may include any sub-combination of the foregoing elements.

The processor 233 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 233 may perform signal coding, data processing, power control, input/output processing, and/or any other functionality that enables the user device 102 to operate in a wireless environment. The processor 233 may be coupled to the transceiver 231, which may be coupled to the transmit/receive clement 221. While FIG. 2 depicts the processor 233 and the transceiver 231 as separate components, it will be appreciated that the processor 233 and the transceiver 231 may be integrated together in an electronic package or chip.

The transmit/receive element 221 may be configured to transmit signals to, or receive signals from, network devices 116A-116B (e.g., a gateway) over the air interface 216. For example, the transmit/receive element 221 may be an antenna configured to transmit and/or receive RF signals. The transmit/receive element 221 may be an emitter/detector configured to transmit and/or receive IR, UV, or visible light signals, for example. The transmit/receive clement 221 may be configured to transmit and/or receive both RF and light signals. It will be appreciated that the transmit/receive element 221 may be configured to transmit and/or receive any combination of wireless signals.

Although the transmit/receive element 221 is depicted in FIG. 2C as a single element, the user device 102 may include any number of transmit/receive elements 221. More specifically, the user device 102 may employ MIMO technology. Thus, the user device 102 may include two or more transmit/receive elements 221 (e.g., multiple antennas) for transmitting and receiving wireless signals over the air interface 216.

The transceiver 231 may be configured to modulate the signals that are to be transmitted by the transmit/receive element 221 and to demodulate the signals that are received by the transmit/receive element 221. As noted above, the user device 102 may have multi-mode capabilities. Thus, the transceiver 231 may include multiple transceivers for enabling the user device 102 to communicate via multiple RATs, such as NR and IEEE 802.11, for example.

The processor 233 of the user device 102 may be coupled to, and may receive user input data from, the speaker/microphone 225, the keypad 226, and/or the display/touchpad 227 (e.g., a liquid crystal display (LCD) display unit or organic light-emitting diode (OLED) display unit). The processor 233 may also output user data to the speaker/microphone 225, the keypad 226, and/or the display/touchpad 227. In addition, the processor 233 may access information from, and store data in, any type of suitable memory, such as the non-removable memory 229 and/or the removable memory 232. The non-removable memory 229 may include random-access memory (RAM), read-only memory (ROM), a hard disk, or any other type of memory storage device. The removable memory 232 may include a subscriber identity module (SIM) card, a memory stick, a secure digital (SD) memory card, and the like. The processor 233 may access information from, and store data in, memory that is not physically located on the user device 102, such as on a server or a home computer (not shown).

The processor 233 may receive power from the power source 234, and may be configured to distribute and/or control the power to the other components in the user device 102. The power source 234 may be any suitable device for powering the user device 102. For example, the power source 234 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 233 may also be coupled to the GPS chipset 236, which may be configured to provide location information (e.g., longitude and latitude) regarding the current location of the user device 102. In addition to, or in lieu of, the information from the GPS chipset 236, the user device 102 may receive location information over the air interface 216 from a base station (e.g., base stations 214a, 214b) and/or determine its location based on the timing of the signals being received from two or more nearby base stations. It will be appreciated that the user device 102 may acquire location information by way of any suitable location-determination method.

The processor 233 may further be coupled to other peripherals 238, which may include one or more software and/or hardware modules that provide additional features, functionality and/or wired or wireless connectivity. For example, the peripherals 238 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 238 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The user device 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 233). The user device 102 may include a half-duplex radio for which transmission and reception of some or all of the signals (e.g., associated with particular subframes for either the UL (e.g., for transmission) or the DL (e.g., for reception)).

The user device 102 may access to a private network and/or a public network via the transmit/receive element 221 and/or the transceiver 231. For example, where a network device 116A (e.g., a gateway, an access point, or the like) provides a private WiFi network and a public WiFi network, the processor 233 of the user device 102 may send, to the network device 116A, a first request to connect to the public WiFi network via the transmit/receive element 221 and/or the transceiver 231. The first request may comprise a random MAC address associated with the user device 102. The network device 116A may determine that the random MAC address is not allowed/authorized to connect to the public WiFi network. The processor 233 of the user device 102 may receive a second request from the network device 116A via the transmit/receive element 221 and/or the transceiver 231. The second request may indicate the processor 233 of the user device 102 to provide user information to connect to the public WiFi network. The processor 233 of the user device 102 may send the user information (e.g., user credentials, user identification, or the like) to the network device 116A. The network device 116A may send the user information and a MAC address associated with the network device to the computing device 104 (e.g., a Radius/AAA server) for further verification. Based on the user information and the MAC address associated with the network device 116A, the user device 102 may connect or may not connect to the public WiFi network via the transmit/receive clement 221 and/or the transceiver 231.

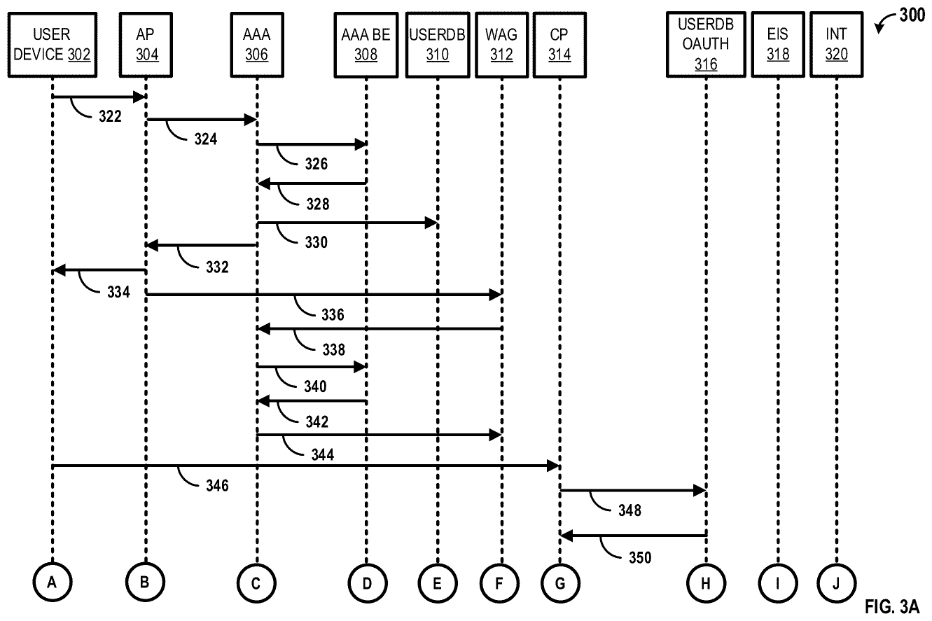

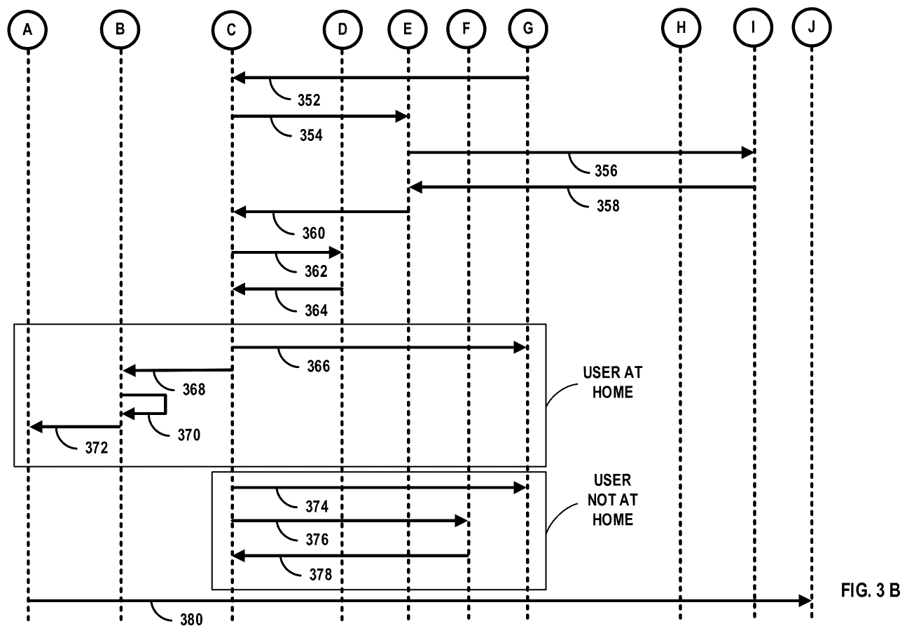

FIGS. 3A and 3B show an example communications flow 300 for determining whether to connect a device to a private network or a public network. The communications flow 300 may be directed to the first call scenario, where user information, subscriber information, or user device information is not known by one or more network servers (e.g., an AAA server 306, USERDB 310, or the like). For example, one or more network servers (e.g., an AAA server 306, USERDB 310, or the like) may not have user information or user device information, such as the MAC address of the user device 320. For example, that information may have been typically provided in a whitelist that allows the access to the network 105. An access point (AP) 304 may be configured to provide a private network and a public network. At 322, the user device 302 may send a message to the AP 304 via the public network. For example, the message may be an association request message to access the public network. For example, the message may include a MAC address, such as a new MAC address of the user device 302. The MAC address may be a random MAC address generated by the user device 302.

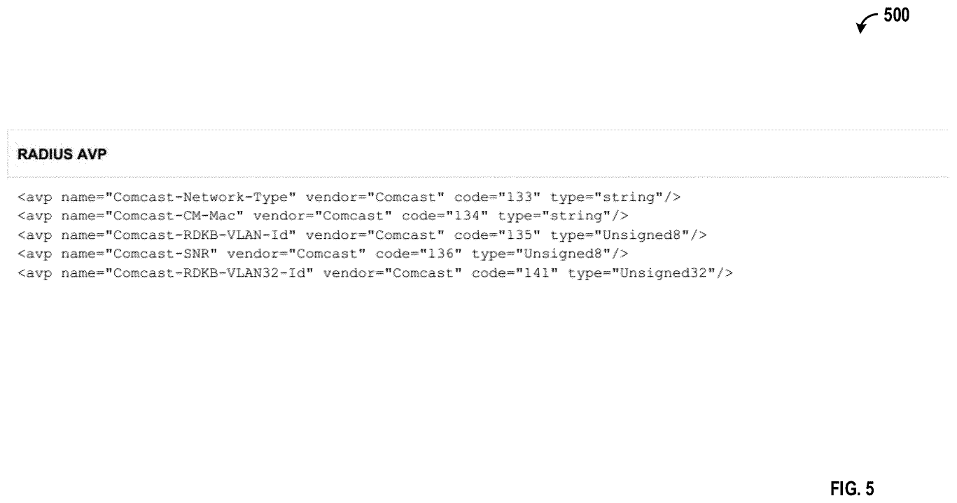

At 324, the AP 304 may send a message to an AAA server 306. For example, the message may be an access request message. The message may comprise the user information (e.g., user credentials), the MAC address of the user device 302 and/or a MAC address of the AP 304. The MAC address of the AP 304 may be included in attribute value pairs (AVPs) as shown in FIG. 5. Based on the user information or the device information in the access request message, the AAA server 306 may determine that it has no prior information on the user device 302. At 326, the AAA server 306 may send a message to a backend server such as AAA-BE 308 to get user information associated with the access request message. For example, the message may be a get UserInfoByMac message or another type of message. The getUserInfoByMac message may comprise the MAC address of the user device 302 and/or the MAC address of the AP 304. The getUserInfoByMac message may indicate the AAA-BE 408 to retrieve the user information associated with the MAC address of the user device 302 and/or the MAC address of the AP 304. At 328, the AAA-BE 308 may send a message to the AAA server 306. For example, the AAA-BE 308 may send the message to the AAA server 306 based on the getUserInfoByMac message. For example, the message may be a noInfo message. For example, if the user information, the user, the subscriber, or the user device 302 is new, the AAA-BE 308 may send the noInfo message to the AAA server 306. The message may comprise an indication indicating that the AAA-BE 308 has no information about the subscriber, the user, or the user device 302.

At 330, the AAA server 306 may send a message to an identity management server such as USERDB 310. The message may comprise a getUserDetails message. For example, the AAA server 306 may send a getUserDetails message to an identity management server such as USERDB 310, based on the noInfo message, to retrieve the user information associated with the association request message at 322 and/or the access request message at 324. The message may include one or more of UE-MAC address, AP-MAC address, AP-IP address, or customer identity (e.g., CUSTGUID). At 332, the AAA-BE 308 may also send a message to the AP 304. For example, the message may comprise an access accept (RM: ACCEPT) message. The AAA-BE 308 may send the access accept message based on the noInfo message at 328. For example, the message may include an error message indicating that the AAA server 306 has no information about the subscriber, the user, or the user device 302. At 334, the AP 304 may send a message to the user device 302. For example, the message may be an ACK or acknowledgement message. The AP 304 may send the ACK message to the user device 302 based on the access accept message indicating the error. For example, the ACK message may indicate that the AP 304 acknowledges the receipt of the association request message received from the user device 302 at 322 but one or more servers (e.g., AAA 306, AAA-BE 308, or the like) have no information.

At 336, the AP 304 may send a message that includes or indicates a data plan associated with the subscriber, the user, or the user device 302, to a wireless access gateway (WAG) 312. For example, the message may be an Ethernet over GRE (EoGRE) message. The AP 304 may send the EoGRE message based on the access accept message indicating the error. Upon receiving the EoGRE, the WAG 312 may search a cache of the WAG 312 to determine if it has an entry that matches the MAC address of the user device 302. If not, at 338, the WAG 312 may send a message to the AAA server 306. For example, the message may comprise an access request message. The WAG 312 may send the access request message to the AAA server 306 to request the AAA 306 the user/subscriber information/credentials. At 340, the AAA server 306 may send a message to the backend server, such as AAA-BE 308, to get user information associated with the access request message. For example, the message may be a getUserInfo message requesting the AAA-BE 308 to retrieve the user/subscriber information/credentials associated with the user device 302. The AAA server 306 may send the getUserInfo message to the backend server, such as AAA-BE 308, based on the access request message. At 342, the AAA-BE 308 may send a response message to the AAA server 306 if the AAA-BE 308 has no information about the subscriber, the user, or the user device 302. For example, the response message may be a noInfo message. The AAA-BE 308 may send the noInfo message to the AAA server 306 based on the getUserInfo message. At 344, the AAA server 306 may send a message to the WAG 312. For example, the message may be an access accept message that redirects the website displayed in the user device 302 to the captive portal (CP) 314. At this point, the user of the user device 302 may be prompted to enter user credentials (e.g., user ID and password) at the user device 302. The AAA server 306 may send the access accept message to the WAG 312 based on the noInfo message. At 346, the user device 302 may send the user credentials to the CP 314. The user device 302 may send the user credentials to the CP 314 based on the access accept message that redirects the website displayed in the user device 302 to the CP 314. At 348, the CP 314 may send a message that includes the user credentials to USERDB_OAUTH 316 (e.g., an identity management portal). For example, the message may comprise a getUserGUID message. For example, the message may be sent based on the CP 314 receiving the user credentials. At 350, the CP 314 may receive a message from the USERDB_OAUTH 316 indicating successful verification/authorization of the user credentials.

At 352, the CP 314 may send a message to the AAA server 306. For example, the message may comprise an Auth(createCache) message. For example, the CP 314 may send the Auth(createCache) message to the AAA server 306 based on the message indicating successful verification/authorization of the user credentials. The Auth(createCache) message may comprise the verified/authorized user credentials. At 354, the AAA server 306 may send a message to the USERDB 310. For example, the message may comprise a getUserDetails message. The AAA server 306 may send the getUserDetails message to the USERDB 310 based on the Auth(createCache) message. The getUserDeails message may include UE-MAC address, AP-MAC address, AP-IP address, and CUSTGUID. At 356, the USERDB 310 may send a message to a database, such as EIS 318. For example, the message may comprise a getUserGWInfo message to receive the gateway or AP information associated with the user device 302. The USERDB 310 may send the getUserGWInfo message to the EIS 318 based on the getUserDetails message. The EIS 318 may include mapping information between the user account/information and the MAC address of network devices such as the gateway or the AP 304 (e.g., a CM MAC address). For example, the mapping information may include one or more MAC addresses of the network devices (e.g., a gateway, an access point, or the like) that are associated with one or more user information such as user identities, a user credentials, user home or residence addresses, or the like. At 358, the EIS 318 may send a message to the USERDB 310 indicating that the EIS 318 successfully identifies whether the user information is mapped to the MAC address of network device.

At 360, the USERDB 310 may send a message to the AAA server 306. For example, the message may comprise a userDetailsRespOk message. The USERDB 310 may send the userDetailRespOk message to the AAA server 306 based on the message indicating that the EIS 318 successfully identified that the user information is mapped to the MAC address of network devices. For example, the USERDB 310 may determine that the MAC address of the AP 304 maps to the MAC address of an AP associated with the user information. Based on the mappings, the userDetailsRespOk message may indicate whether the association request message at 324 is received from the network device (e.g., a gateway or the AP 304, or the like) located in the user's home or residence. At 362, the AAA server 306 may send a message to the AAA-BE 308. For example, the message may comprise a createCacheEntry message. The AAA server 306 may send the createCacheEntry message to the AAA-BE 308 based on the userDetailsRespOk message. The createCacheEntry message may indicate the AAA-BE 308 to create a cache entry with the user information and the MAC address of network devices. At 364, the AAA-BE 308 may send an OK message to the AAA server 306 as a response.

In examples where the user device 302 is located in the user's home or residence, at 366, the AAA server 306 may send a message (e.g., an error message) indicating that the user and/or the user device 302 is located in the user's home. For example, the AAA server 306 may send the error message based on the userDetailsRespOk message indicating that the association request message at 324 is received by the network device (e.g., a gateway or the AP 304, or the like) located in the user's home or residence. At 368, the AAA server 306 may send a message to the AP 304. For example, the message may comprise a disconnect request message. The AAA server 306 may send the disconnect request message to the AP 304 based on the userDetailsRespOk message indicating that the association request message at 324 is received by the network device (e.g., a gateway or the AP 304, or the like) located in the user's home or residence. For example, by sending the disconnect request message to the AP 304, the AAA server 306 may cause the AP 304 not to allow the user device 302 to access the public network provided by the AP 304.

At 370, the AP 304 may add the MAC address of the user device 302 to an access deny list (e.g., grey list). For example, the AP 304 may add the MAC address of the user device 302 to an access deny list (e.g., grey list) based on the disconnect request message. The AP 304 may add the MAC address of the user device 302 to the access deny list (e.g., grey list) to prevent the user device 302 from accessing the network (e.g., the public network) provided by the AP 304 after the first association request. For example, the MAC address of the user device 302 may remain in the access deny list (e.g., grey list) for a predetermined amount of time. For example, the predetermined amount of time may be anywhere between and including 1 minute to 1 week. For example, the predetermined amount of time may be 24 hours and the MAC address of the user device 302 may be deleted from the access deny list (e.g., grey list) after the 24 hours expire. At 372, the AP 304 may send a message to the user device 302. For example, the message may be an UnAssociate message. The AP 304 may send the UnAssociate message to the user device 302 based on the disconnect request message. For example, the UnAsociate message may cause the user device 302 to disconnect from the network (e.g., the public network) provided by the access point 304. After the disconnection from the network (e.g., the public network), the user device 302 may further scan one or more other networks (e.g., a private network) provided by the access point 304.

In examples where the user device 302 is located outside of the user's home, at 374, the AAA server 306 may send a message to the CP 314. For example, the message may comprise a success message. For example, the AAA server 306 may send the success message based on the userDetailsRespOk message indicating that the association request message at 324 is received by the network device (e.g., a gateway or the AP 304, or the like) located outside of the user's home or residence. The success message may indicate that the association request message at 324 is received by the network device (e.g., a gateway or the AP 304, or the like) located outside of the user's home or residence. At 376, the AAA server 306 may also send a message to the WAG 312. For example, the message may comprise an AUTH CoA message. For example, the message may request a change of authentication by the WAG 312. For example, at this stage, the user device 302 may not be authorized yet by the AAA 306 but needs to be authorized by a different entity such as the AAA-BE 308. The AAA 306 may request the WAG 312 to change the authorization entity from the AAA 306 to the AAA-BE 308 by sending the AUTH CoA message. At 378, the WAG 312 may send a message to the AAA server 306 acknowledging the change of authentication. At 380, the user device 302 may access the Internet 320 via the network (e.g., public network) provided by the network device (e.g., a gateway or the AP 304, or the like).

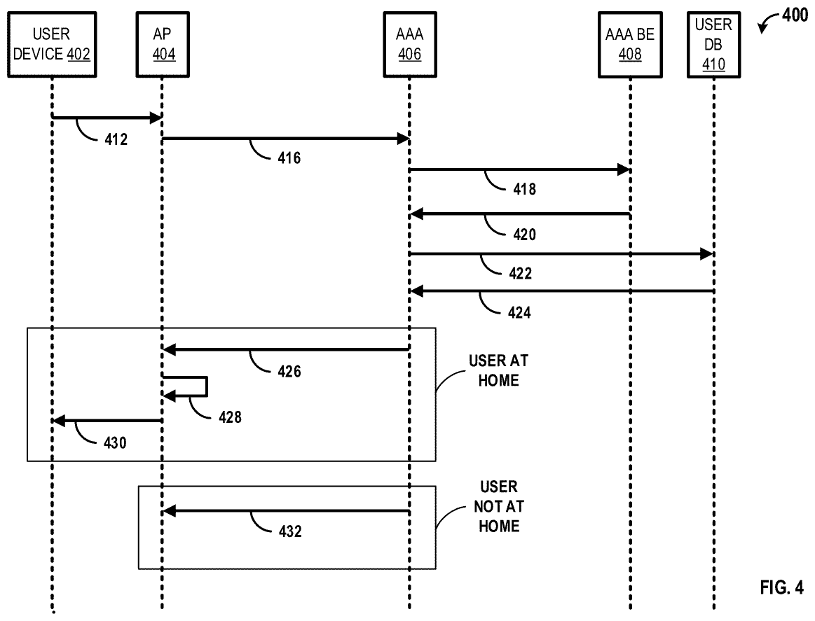

FIG. 4 shows an example flowchart 400 for determining whether to connect a device to a private network or a public network. The communications flow 400 may be directed to the automatic sign-in (AIS) scenario where user information, subscriber information, or user device 402 information is known by one or more network servers (e.g., an AAA server 406, USERDB 410, or the like). For example, one or more network servers (e.g., an AAA server 406, USERDB 410, or the like) may have user device information, such as the MAC address of the user device 420, for example, in a list, such as a whitelist, that is referenced to determine if the user device 420 is permitted to access to the network 105. For example, the network 105 may comprise a public network and a private network. For example, AP 404 may be configured to provide connection capabilities to multiple networks, such as the public network and the private network. At 412, the user device 402 may send a message to an AP 404. For example, the message may be an association request message to access the public network. For example, the message may include a MAC address, such as a new MAC address of the user device 402. The MAC address may be a random MAC address generated by the user device 402. The message may include user information such as user credentials

At 416, the AP 404 may send a message to an AAA server 406. For example, the message may be an access request message. The message may comprise the user information (e.g., user credentials), the MAC address of the user device 302 and/or a MAC address of the AP 404. The MAC address of the AP 404 may be included in attribute value pairs (AVPs) as shown in FIG. 5. For example, the AP 404 may send the MAC address of the AP 404 (e.g., CM MAC address) in an access request message to the AAA server 406. At 418, the AAA server 406 may send a message to a backend server such as AAA-BE 408 to get user information associated with the access request message. For example, the message may be a getUserInfoByMac message or another type of message. The getUserInfoByMac message may comprise the MAC address of the user device 402 and/or the MAC address of the AP 404. The getUserInfoByMac message may indicate the AAA-BE 408 to retrieve the user information associated with the MAC address of the user device 402 and/or the MAC address of the AP 404. At 420, In response to the getUserInfoByMac message, the AAA-BE 408 may send a message to the AAA server 406. For example, the message may be a noInfo message. For example, if the user information, the user, the subscriber, or the user device 402 is new, the AAA-BE 408 may send a noInfo message to the AAA server 406. The message may comprise an indication indicating that the AAA-BE 408 has no information about the subscriber, the user, or the user device 402.

At 422, the AAA server 406 may send a message to an identity management server such as USERDB 410. The message may comprise a getUserDetails message. For example, the AAA server 406 may send a getUserDetails message to an identity management server such as USERDB 310, based on the noInfo message, to retrieve the user information associated with the association request message at 412 and/or the access request message at 416. The message may include UE-MAC, AP-MAC, AP-IP, and customer identity (e.g., CUSTGUID). At 424, the USERDB 410 may send a message to the AAA server 406. For example, the message may comprise a userDetailsRespOk message. The USERDB 410 may send the userDetailRespOk message to the AAA server 406 based on the mapping information between the MAC addresses associated with the user account/information and the MAC address of network devices such as the gateway or the AP 404 (e.g., a CM MAC address). For example, the mapping information may include one or more MAC addresses of the network devices (e.g., a gateway, the access point 404, or the like) that are associated with one or more user information such as user identities, user credentials, user home or residence addresses, or the like. Based on the mapping information, the USERDB 410 may identify whether the MAC adderss associated with the user information is mapped to the MAC address of network device (e.g., AP 304) that received the associate request message at 412. For example, the USERDB 410 may determine that the MAC address of the AP 304 maps to the MAC address of an AP associated with the user information. Based on the mapping, the userDetailsRespOk message may indicate whether the association request message at 412 is received by the network device (e.g., a gateway or the AP 404, or the like) located in the user's home or residence. For example, the userDetailsRespOk message may include an access accept indication or an access reject indication determined based on the mapping information. For example, the access accept indication may indicate that the association request message at 412 is received by the network device (e.g., a gateway or the AP 404, or the like) located outside of the user's home or residence. The access reject indication may indicate that the association request message at 412 is received by the network device (e.g., a gateway or the AP 404, or the like) located in the user's home or residence.

In examples where the user device 402 is located in the user's home or residence, at 426, the AAA server 406 may send a message to the AP 404. For example, the message may comprise an access reject (Response Message (RM): GREY LIST) message. The AAA server 406 may send the access reject message to the AP 404 based on the userDetailsRespOk message indicating that the association request message at 412 is received by the network device (e.g., a gateway or the AP 404, or the like) located in the user's home or residence. For example, by sending the access reject message to the AP 404, the AAA server 406 may cause the AP 404 not to allow the user device 402 to access the public network provided by the AP 404. At 428, the AP 404 may add the MAC address of the user device 402 to an access deny list (e.g., grey list). For example, the AP 404 may add the MAC address of the user device 402 to an access deny list (e.g., grey list) based on the access reject message. The AP 404 may add the MAC address of the user device 302 to the access deny list (e.g., grey list) to prevent the user device 402 from accessing the network (e.g., the public network) provided by the AP 404 after the first association request. For example, the MAC address of the user device 402 may remain in the access deny list (e.g., grey list) for a predetermined amount of time. For example, the predetermined amount of time may be anywhere between and including 1 minute to 1 week. For example, the predetermined amount of time may be 24 hours and the MAC address of the user device 402 may be deleted from the access deny list (e.g., grey list) after the 24 hours expire. At 430, the AP 404 may send a message to the user device 402. For example, the message may be an UnAssociate message. The AP 404 may send the UnAssociate message to the user device 402 based on the access reject message. For example, the UnAsociate message may cause the user device 402 to disconnect from the network (e.g., the public network) provided by the access point 404. After the disconnection from the network (e.g., the public network), the user device 402 may further scan one or more other networks (e.g., a private network) provided by the access point 404.

In examples where the user device 402 is located outside of the user's home or residence, at 432, the AAA server 406 may send a message to the AP 404. For example, the message may comprise an access accept (RM: accept) message. The AAA server 406 may send the access accept message to the AP 404 based on the userDetailsRespOk message indicating that the association request message at 412 is received by the network device (e.g., a gateway or the AP 404, or the like) located outside the user's home or residence. For example, based on the access accept message to the AP 404, the AAA server 406 may cause the AP 404 to allow the user device 402 to access the public network provided by the AP 404. Based on the access accept message, the AP 404 may provide the user device 402 access to the public network.

FIG. 5 shows example network parameters 500. The network parameters 500 may refer to attribute value pairs (AVPs). As shown in FIG. 5, the AVPs may include, but are not limited to, a network type, a MAC address, one or more VLAN IDs, and signal-to-noise ratio (SNR). The MAC address in the AVPs may be a MAC address of the network device 116A or 116B. For example, the MAC address may be a cable modem (CM) MAC address, an access point MAC, and/or a gateway MAC address. One or more VLAN IDs may be an integer with four or eight bytes that logically divides a physical network into multiple virtual networks.

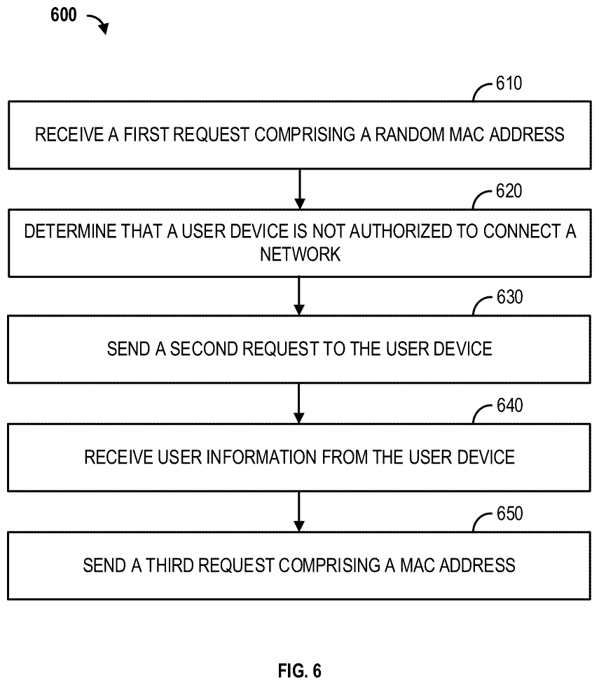

FIG. 6 shows an example method 600 for determining whether to connect a device to a private network or a public network. The method 600 may be performed by any device described herein, such as the user device 102, the network devices 116A-116B, and the computing device 104. At 610, a first request that includes a random MAC address may be received. For example, a first computing device (e.g., a gateway, an access point, or the like) may be configured to provide a first network and a second network. For example, the first computing device 116A may receive the first request from the user device 102. For example, the first request may be a request for the user device 102 to connect to the first network. For example, the first network may be a public or publicly accessible network and the second network may be a private network. The first request may comprise the random MAC address associated with (e.g., identifying) the user device 102. The random MAC address may refer to a Media Access Control address generated dynamically and not permanently associated with a specific network device such as the user device 102. The user device 102 may use the randomized or temporary MAC address when connecting to the first network or the second network. Each time the user device 102 connects to a network, the user device 102 may generate a new, random MAC address to identify the user device 102.

At 620, whether the user device 102 is allowed/authorized to connect to the first network may be determined. For example, the first computing device (e.g., a gateway, an access point, or the like) may determine that the user device 102 is not authorized to connect to the first network. For example, the first computing device (e.g., a gateway, an access point, or the like) may determine the user device 102 not authorized to connect to the first network based on the random MAC address. For example, the first computing device (e.g., a gateway, an access point, or the like) may compare the random MAC address of the user device 102 with an allowlist/whitelist or a denylist/blacklist. For example, if the random MAC address is not in the allowlist or whitelist, the first computing device (e.g., a gateway, an access point, or the like) may determine that the user device 102 associated with the random MAC address is not authorized to connect to the first network.

At 630, a second request for user information may be sent. For example, if the user device 102 is not authorized to connect to the first network, the first computing device (e.g., a gateway, an access point, or the like) may send the second request to the user device 102. The second request may indicate to the user device 102, or to a user associated with the user device 102, to provide the user information (e.g., user credentials, user identity, user password, etc.) to connect to the first network. At 640, the user information may be received. For example, in response to the second request, the first computing device (e.g., a gateway, an access point, or the like) may receive the user information from the user device 102. The user information may include, but is not limited to, the user identity and the user password.

At 650, a third request may be sent. For example, the third request may be an authorization request. For example, the third request may be sent based on receiving the user information from the user device 102. For example, the first computing device (e.g., a gateway, an access point, or the like) may send the third request to a second computing device (e.g., an AAA server, a RADIUS server, an identity management server, or the like). The third request may comprise the user information and a MAC address associated with (e.g., identifying) the first computing device (e.g., a gateway, an access point, or the like). Alternatively or additionally, the third request may comprise the user information and the AVPs shown in FIG. 5.

A response message may be received by the first computing device. For example, the first computing device may receive the response message based on the third request. For example, the response message may comprise an access accept message or an access reject message. For example, the access accept message may indicate that the user device 102 may access the first network. For example, the access reject message may indicate that the user device 102 should not connect with the first network (e.g., the public network) and instead should be connected to the second network (e.g., the private network). For example, the first computing device (e.g., a gateway, an access point, or the like) may receive, from the second computing device (e.g., an AAA server, a RADIUS server, an identity management server, or the like), the access accept message or the access reject message. The access accept message or the access reject message may be received based on the user information and the MAC address associated with the first computing device (e.g., a gateway, an access point, or the like).

The second computing device (e.g., an AAA server, a RADIUS server, an identity management server, or the like) may determine whether the first request to connect the first network (e.g., the public network) is received by the first computing device (e.g., a gateway, an access point, or the like) that is located in the user's home or residence, based on the user information and the MAC address associated with the first computing device (e.g., a gateway, an access point, or the like). For example, based on the third request that comprises the user information and the MAC address of the first computing device, the second computing device may determine whether the MAC address of the first computing device corresponds to the MAC address of a computing device (e.g., a gateway, an access point, or the like) associated with the user information.

If the first request to connect the first network is received by the first computing device located in the user's home or residence, the second computing device may find that the MAC address of the first computing device matches the MAC address of the computing device (e.g., a gateway, an access point, or the like) associated with the user information. For example, the second computing device may communicate with one or more other computing devices (e.g., backend server, user database, or the like) to determine that the MAC address of the first computing device matches the MAC address of the computing device (e.g., a gateway, an access point, or the like) associated with the user information. The second computing device may then send the access reject message indicating that the first computing device should not allow the user device 102 to connect to the first network (e.g., the public network). The access reject message may indicate that the first request to connect the first network (e.g., the public network) is received by the first computing device located in the use's home or residence.

If the first request to connect the first network (e.g., the public network) is received by the first computing device located outside of the user's home or residence, the second computing device may not find that the MAC address of the first computing device matches the MAC address of the computing device (e.g., a gateway, an access point, or the like) associated with the user information. For example, the second computing device may communicate with other computing devices (e.g., backend server, user database, or the like) to determine that the first request to connect the first network (e.g., the public network) is received by the first computing device (e.g., a gateway, an access point, or the like) that is located outside of the user's home or residence. The second computing device may then send the access accept message indicating that the first computing device should allow the user device 102 to connect to the first network (e.g., the public network). The access accept message may indicate that the first request to connect the first network (e.g., the public network) is received by the first computing device located outside of the user's home or residence.

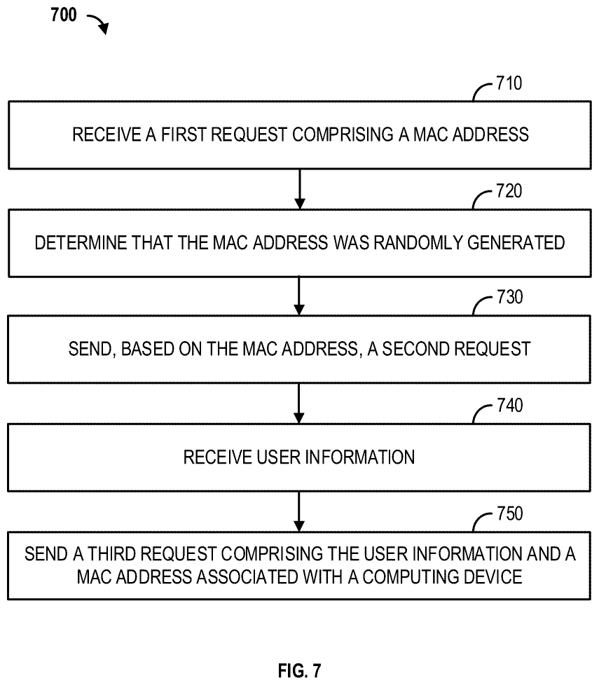

FIG. 7 shows an example method 700 for determining whether to connect a device to a private network or a public network. The method 700 may be performed by any device such as the user device 102, the network devices 116A-116B, and the computing device 104. At 710, a first request that includes a MAC address may be received. For example, a first computing device (e.g., a gateway, an access point, or the like) may be configured to provide a public network and a private network. For example, the first computing device may receive the first request from the user device 102. For example, the first request may be a request for the user device 102 to connect to the first network (e.g., a public network). For example, the first network may be a public or publicly accessible network and the second network may be a private network. The first request may comprise the MAC address associated with the user device 102. At 720, whether the MAC address was randomly generated may be determined. For example, the first computing device (e.g., a gateway, an access point, or the like) may determine that the MAC address was randomly generated. For example, the MAC address randomly generated may be determined based on at least one of an organizationally unique identifier of the MAC address, a pattern in the MAC address, or a frequency of changes in the MAC address.

At 730, a second request for user information may be sent. For example, the first computing device may send the second request to the user device 102. The first computing device may send the second request based on the randomly-generated MAC address. For example, if the MAC address is determined to be randomly generated, the first computing device (e.g., a gateway, an access point, or the like) may send the second request to the user device 102. The second request may indicate the user device 102 to provide the use information (e.g., user credentials, user identity, user password, etc.) to connect to the first network (e.g., a public network). At 740, the user information may be received. For example, the first computing device (e.g., a gateway, an access point, or the like) may receive the user information. The user information may include, but is not limited to, the user identity and the user password.

At 750, a third request may be sent. For example, the third request may be an authorization request. For example, the third request may be sent based on the receiving the user information. For example, the first computing device (e.g., a gateway, an access point, or the like) may send the third request to a second computing device (e.g., an AAA server, a RADIUS server, an identity management server, or the like). The third request may comprise the user information and a MAC address associated with the first computing device (e.g., a gateway, an access point, or the like). Alternatively or additionally, the third request may comprise the user information and the AVPs shown in FIG. 5.

A response message may be received by the first computing device. For example, the first computing device may receive the response message based on the third request. For example, the response message may comprise an access accept message or an access reject message. For example, the access accept message may indicate that the user device 102 may access the first network. For example, the access reject message may indicate that the user device 102 should not connect with the first network (e.g., the public network) and instead should be connected to the second network (e.g., the private network). For example, the first computing device (e.g., a gateway, an access point, or the like) may receive, from the second computing device (e.g., an AAA server, a RADIUS server, an identity management server, or the like), the access accept message or the access reject message. The access accept message or the access reject message may be received based on the user information and the MAC address associated with the first computing device (e.g., a gateway, an access point, or the like).

The second computing device (e.g., an AAA server, a RADIUS server, an identity management server, or the like) may determine whether the first request to connect the first network (e.g., the public network) is received by the first computing device (e.g., a gateway, an access point, or the like) that is located in the user's home or residence, based on the user information and the MAC address associated with the first computing device (e.g., a gateway, an access point, or the like). For example, based on the third request that comprises the user information and the MAC address of the first computing device, the second computing device may determine whether the MAC address of the first computing device corresponds to the MAC address of a computing device (e.g., a gateway, an access point, or the like) associated with the user information.

If the first request to connect the first network is received by the first computing device located in the user's home or residence, the second computing device may find that the MAC address of the first computing device matches the MAC address of the computing device (e.g., a gateway, an access point, or the like) associated with the user information. For example, the second computing device may communicate with one or more other computing devices (e.g., backend server, user database, or the like) to determine that the MAC address of the first computing device matches the MAC address of the computing device (e.g., a gateway, an access point, or the like) associated with the user information. The second computing device may then send the access reject message indicating that the first computing device should not allow the user device 102 to connect to the first network (e.g., the public network). The access reject message may also indicate that the first request to connect the first network (e.g., the public network) is received by the first computing device located in the use's home or residence.

If the first request to connect the first network (e.g., the public network) is received by the first computing device located outside of the user's home or residence, the second computing device may not find that the MAC address of the first computing device matches the MAC address of the computing device (e.g., a gateway, an access point, or the like) associated with the user information. For example, the second computing device may communicate with one or more other computing devices (e.g., backend server, user database, or the like) to determine that the MAC address of the first computing device does not match the MAC address of the computing device (e.g., a gateway, an access point, or the like) associated with the user information. The second computing device may then send the access accept message indicating that the first computing device should allow the user device 102 to connect to the first network (e.g., the public network). The access accept message may also indicate that the first request to connect the first network (e.g., the public network) is received by the first computing device located outside of the user's home or residence.

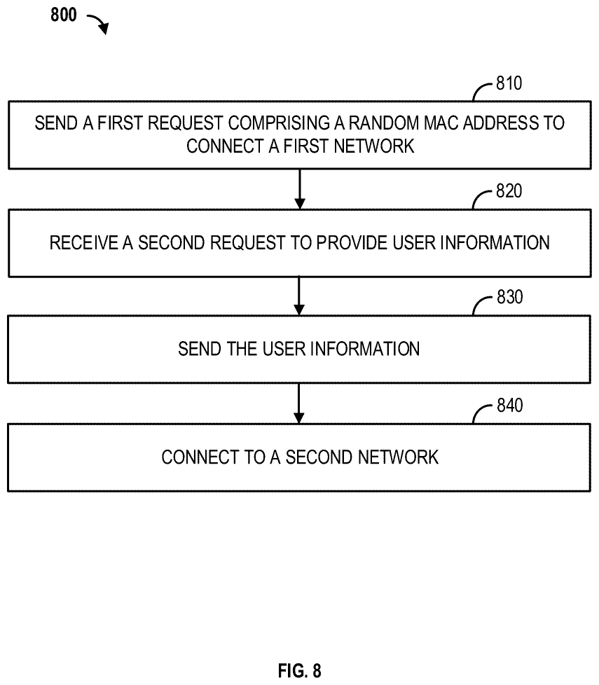

FIG. 8 shows an example method 800 for determining whether to connect a device to a private network or a public network. The method 800 may be performed by any device, such as the user device 102, the network devices 116A-116B, and the computing device 104. At 810, a first request that includes a random MAC address may be sent. For example, the user device 102 may send the first request to a computing device (e.g., a gateway, an access point, or the like). The computing device (e.g., a gateway, an access point, or the like) may be configured to provide a first network and a second network. The first network may be a public or publicly accessible network and the second network may be a private network. For example, the user device 102 may detect multiple networks such as the first network and the second network and select the first network to connect. For example, the user device 102 may select the first network based on previous connection information, the order of the network IDs, a network preference, a network policy, or the like. The first request may comprise the random MAC address associated with the user device 102. The random MAC address may be generated dynamically and not permanently associated with a specific network device such as the user device 102. The user device 102 may use the randomized or temporary MAC address when connecting to the first network or the second network. Each time the user device 102 connects to a network, the user device 102 may generate a new, random MAC address.

At 820, a second request for user information may be received. For example, the user device 102 may receive the second request from the computing device (e.g., a gateway, an access point, or the like). The second request may indicate the user device 102, or to a user associated with the user device 102, to provide the user information such as user credentials, user identity, and user password. The second request may be received based on that the computing device (e.g., a gateway, an access point, or the like) determines the random MAC address is not authorized to connect to the first network. For example, the computing device (e.g., a gateway, an access point, or the like) may compare the random MAC address of the user device 102 with an allowlist/whitelist or a denylist/blacklist to determine whether to send the second request. If the random MAC address is not in the allowlist or whitelist, the computing device (e.g., a gateway, an access point, or the like) may determine that the user device 102 is not authorized to connect to the first network and send the second request to the user device 102.

At 830, the user information may be sent. For example, the user device 102 may send the user information to the computing device (e.g., a gateway, an access point, or the like). As described above, the user information may include, but is not limited to, the user identity and the user password. At 840, the first network may be connected to the user device 102. For example, the user device 102 may connect to the first network. For example, the user device 102 may connect to the first network based on a response message from the computing device. The response message may be received by the user device 102 based on the user information. For example, the computing device may receive the user information and send the user information and the MAC address associated with the computing device. The user information and the MAC address associated with the computing device may be sent to one or more other computing devices (e.g., an AAA server, a RADIUS server, an identity management server, or the like). Based on the user information and the MAC address associated with the computing device, the computing device may receive an access accept message or an access reject message. For example, the access accept message may indicate that the user device 102 may access the first network. For example, the access reject message may indicate that the user device 102 should not connect with the first network (e.g., the public network) and instead should be connected to the second network (e.g., the private network). Based on the access accept message or the access reject message, the computing device may send the response message to the user device 102. If the user device 102 receives the response message indicating the access accept, the user device 102 may connect to the first network. If the user device 102 receives the response message indicating the access reject, the user device 102 may not connect to the first network, and instead connect to the second network.

The one or more other computing devices (e.g., an AAA server, a RADIUS server, an identity management server, or the like) may determine whether the first request to connect the first network (e.g., the public network) is received by the computing device (e.g., a gateway, an access point, or the like) that is located in the user's home or residence, based on the user information and the MAC address associated with the computing device (e.g., a gateway, an access point, or the like). For example, based on the user information and the MAC address of the computing device, the one or more computing devices may determine whether the received MAC address of the computing device corresponds to the MAC address of a computing device (e.g., a gateway, an access point, or the like) associated with the user information.

If the first request to connect the first network is received by the computing device located in the user's home or residence, the one or more computing devices determine that the received MAC address of the computing device matches the MAC address of the computing device (e.g., a gateway, an access point, or the like) associated with the user information. The one or more computing devices may then send the access reject message indicating that the computing device should not allow the user device 102 to connect to the first network (e.g., the public network). If the first request to connect the first network (e.g., the public network) is received by the computing device located outside of the user's home or residence, the one or more computing devices may determine that the received MAC address of the first computing device does not match the MAC address of the computing device (e.g., a gateway, an access point, or the like) associated with the user information. The one or more computing devices may then send the access accept message indicating that the computing device should allow the user device 102 to connect to the first network (e.g., the public network).

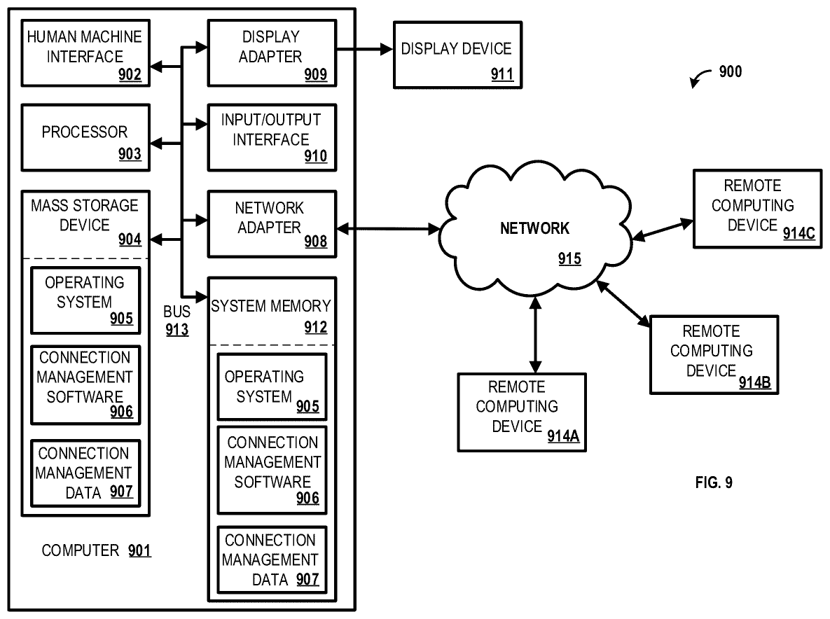

The methods described herein may be implemented on a computer 901 as illustrated in FIG. 9 and described below. By way of example, the user device 102, the network device 116A-116B, and the computing device 104 of FIG. 1 and the user device 102 of FIG. 2 may each be a computer 901 as illustrated in FIG. 9. Similarly, the methods described herein may utilize one or more computers to perform one or more functions in one or more locations. FIG. 9 is a block diagram 900 illustrating an operating environment for performing the described methods. This operating environment is only an example of an operating environment and is not intended to suggest any limitation as to the scope of use or functionality of operating environment architecture. Neither should the operating environment be interpreted as having any dependency or requirement relating to any one or combination of components illustrated in the operating environment.

The present methods for steering devices to a private network over a public network may be operational with numerous other general purpose or special purpose computing system environments or configurations. Examples of well-known computing systems, environments, and/or configurations that may be suitable for use with the systems and methods may comprise, but are not limited to, network devices, security devices, personal computers, server computers, laptop devices, and multiprocessor systems. Additional examples may comprise programmable consumer electronics, network PCs, minicomputers, mainframe computers, distributed computing environments that comprise any of the above systems or devices, and the like.

The processing of the described methods may be performed by software components. The described systems and methods may be described in the general context of computer-executable instructions, such as program modules, being executed by one or more computers or other devices. Generally, program modules comprise computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 901. The components of the computer 901 may comprise, but are not limited to, one or more processors or processing units 903, a system memory 912, and a system bus 913 that couples various system components including the processing unit 903 to the system memory 912. In the case of multiple processing units 903, the system may utilize parallel computing.

The system bus 913 represents one or more of several possible types of bus structures, including a memory bus or memory controller, a peripheral bus, an accelerated graphics port, and a processor or local bus using any of a variety of bus architectures. By way of example, such architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnects (PCI), a PCI-Express bus, a Personal Computer Memory Card Industry Association (PCMCIA), Universal Serial Bus (USB) and the like. The bus 913, and all buses specified in this description may also be implemented over a wired or wireless network connection and each of the subsystems, including the processing unit 903, a mass storage device 904, an operating system 905, security system software 906, security system policies 907, a network adapter 908, system memory 912, an Input/Output Interface 910, a display adapter 909, a display device 911, and a human-machine interface 902, may be contained within one or more remote computing devices 914A,B,C at physically separate locations, connected through buses of this form, in effect implementing a fully distributed system.

The computer 901 typically comprises a variety of computer-readable media. Examples of computer-readable media may be any available media that is accessible by the computer 901 and comprises, for example, both volatile and non-volatile media, removable and non-removable media. The system memory 912 comprises computer-readable media in the form of volatile memory, such as random access memory (RAM), and/or non-volatile memory, such as read only memory (ROM). The system memory 912 typically contains data such as security system policies 907 and/or program modules such as operating system 905 and security system software 906 that are immediately accessible to and/or are presently operated on by the processing unit 903. The connection management software 906 may perform the methods described in FIGS. 3A-4 and FIGS. 6-8.

In another aspect, the computer 901 may also comprise other removable/non-removable, volatile/non-volatile computer storage media. By way of example, FIG. 9 illustrates a mass storage device 904 which may provide non-volatile storage of computer code, computer-readable instructions, data structures, program modules, and other data for the computer 901. For example, a mass storage device 904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 904, including by way of example, an operating system 905 and security system software 906. Each of the operating system 905 and security system software 906 (or some combination thereof) may comprise elements of the programming and the security system software 906. Security system policies 907 may also be stored on the mass storage device 904. Security system policies 907 may be stored in any of one or more databases known in the art. Examples of such databases may comprise, DB2®, Microsoft® Access, Microsoft® SQL Server, Oracle®, mySQL, PostgreSQL, Mongo DB, Riak, HBase, Cassandra, and the like. The databases may be centralized or distributed across multiple systems.

In another aspect, the user may enter commands and information into the computer 901 via an input device (not shown). Examples of such input devices may comprise, but are not limited to, a keyboard, a pointing device (e.g., a “mouse”), a microphone, a joystick, a scanner, tactile input devices such as gloves, and other body coverings, and the like These and other input devices may be connected to the processing unit 903 via a human-machine interface 902 that is in communication with the system bus 913, but may be connected by other interface and bus structures, such as a parallel port, game port, an IEEE 1394 Port (also known as a Firewire port), a serial port, or a universal serial bus (USB).

In yet another aspect, a display device 911 may also be connected to the system bus 913 via an interface, such as a display adapter 909. It is contemplated that the computer 901 may have more than one display adapter 909 and the computer 901 may have more than one display device 911. For example, a display device may be a monitor, an LCD (Liquid Crystal Display), or a projector. In addition to the display device 911, other output peripheral devices may comprise components such as speakers (not shown) and a printer (not shown) which may be connected to the computer 901 via Input/Output Interface 910. Any step and/or result of the methods may be output in any form to an output device. Such output may be any form of visual representation, including, but not limited to, textual, graphical, animation, audio, tactile, and the like. The display 911 and computer 901 may be part of one device, or separate devices.

The computer 901 may operate in a networked environment using logical connections to one or more remote computing devices 914A,B,C. By way of example, a remote computing device may be a network device, security device, personal computer, portable computer, smartphone, a server, a router, a network computer, a peer device or other common network node, and so on. Logical connections between the computer 901 and a remote computing device 914A,B,C may be made via a network 915, such as a local area network (LAN) and/or a general wide area network (WAN). Such network connections may be through a network adapter 908. A network adapter 908 may be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components reside at various times in different storage components of the computer 901, and are executed by the data processor(s) of the computer. An implementation of security system software 906 may be stored on or transmitted across some form of computer-readable media. Any of the described methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Examples of computer storage media may comprise, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
receiving, by a first computing device configured to provide access to a first network, from a user device, a first request to connect to the first network, wherein the first request comprises a random Media Access Control (MAC) address associated with the user device;
determining, based on the random MAC address, that the user device is not authorized to connect to the first network;
sending, to the user device, a second request for the user device to provide user information to connect to the first network;
receiving, from the user device, the user information associated with the user device; and
sending, to a second computing device, a third request that comprises the user information and a MAC address associated with the first computing device.

2. The method of claim 1, wherein the user information associated with the user device comprises a user identifier and a user password.

3. The method of claim 1, further comprising:
receiving, from the second computing device, based on the user information and the MAC address associated with the first computing device, a response indicating that the first request is received by the first computing device located outside of a user's residence associated with the user information; and
allowing, based on the response, the user device to access the first network.

4. The method of claim 3,further comprising:
adding, based on the response, at least one of the random MAC address or a MAC address associated with the user device, in an access allow list for a period of time.

5. The method of claim 1, further comprising:
receiving, from the second computing device, based on the user information and the MAC address associated with the first computing device, a response indicating that the first request is received by the first computing device located in a user's residence associated with the user information;
denying, based on the response, the user device access to the first network; and
providing the user device access to a second network.

6. The method of claim 5, wherein the first computing device is configured to provide the first network and the second network.

7. The method of claim 6, wherein the first network is a public network and the second network is a private network.

8. The method of claim 5, further comprising:
adding, based on the response, at least one of the random MAC address or a MAC address associated with the user device, in an access deny list for a period of time.

9. The method of claim 1, wherein determining that the user device is not authorized to connect to the first network comprises:
comparing the random MAC address with one or more MAC addresses in an access allow list or an access deny list.

10. The method of claim 1, wherein the third request further comprises at least one of a network type, a signal to noise ratio, or one or more Virtual Local Area Network (VLAN) identifiers.

11. The method of claim 1, wherein the first computing device is a gateway device or an access point, and the second computing device is a server.

12. A method comprising:
receiving, by a first computing device configured to provide access to a first network, from a user device, a first request to connect to the first network, wherein the first request comprises a Media Access Control (MAC) address associated with the user device;
determining that the MAC address associated with the user device was randomly generated;
sending, to the user device, based on the MAC address being randomly generated, a second request for the user device to provide user information to connect to the first network;
receiving, from the user device, the user information associated with the user device; and
sending, to a second computing device, a third request that comprises the user information and a MAC address associated with the first computing device.

13. The method of claim 12, further comprising:
receiving, from the second computing device, based on the user information and the MAC address associated with the first computing device, a response indicating that the first request is received by the first computing device located in a user's residence associated with the user information;
denying, based on the response, the user device access to the first network; and
providing the user device access to a second network.

14. The method of claim 13, wherein the first computing device is configured to provide the first network and the second network.

15. The method of claim 13, wherein the first network is a public network and the second network is a private network, and wherein the first computing device is a gateway device or an access point, and the second computing device is a server.

16. The method of claim 12, wherein determining the MAC address associated with the user device was randomly generated further comprises:
determining, based on at least one of an organizationally unique identifier of the MAC address associated with the user device, one or more patterns in the MAC address associated the user device, or a frequency of changes of the MAC address associated with the user device, that the MAC address associated with the user device was randomly generated.

17. A method comprising:
sending, by a user device, to a computing device configured to provide access to a first network and a second network, a first request to connect to the first network, wherein the first request comprises a random Media Access Control (MAC) address associated with the user device;
receiving, from the computing device, based on the random MAC address, a second request to provide user information to connect to the first network;
sending, to the computing device, the user information associated with the user device; and
connecting, based on the user information and a MAC address associated with the computing device, to the second network.

18. The method of claim 17, further comprising:
receiving, from the computing device, a response indicating that the user device is not allowed to connect to the first network; and
sending, by the user device, a third request to connect to the second network.

19. The method of claim 18, wherein the response is determined based on that the first request is received by the computing device located in a user's residence associated with the user information.

20. The method of claim 17, wherein the first network is a public network and the second network is a private network.
